(19) United States
(12) Patent Application Publication
(10) Pub. No.: US 2007/0144848 A1
(43) Pub. Date: Jun. 28, 2007

(54) HYDRAULIC DAMPER FOR VEHICLE

(76) Inventor: TAKUYA SAITO, Kakegawa-shi (JP)

Correspondence Address: Ernest A Beutler Attorney at Law, 10 Rue Marseille, Newport Beach, CA, 92660, US

(21) Appl. No.: 11/613,288

(22) Filed: Dec. 20, 2006

(30) Foreign Application Priority Data
Dec. 28, 2005 (JP) 2005-376807

(51) Int. Cl. F16F 9/00

(52) U.S. Cl. 188/314

(57) ABSTRACT

An improved fluid damping unit of the piston cylinder type that provides substantially equal damping in each direction and improved damping by displacing the full cross sectional area of the piston in each direction and quicker response upon reversal between jounce and rebound.

### BACKGROUND OF THE INVENTION

This invention relates to a hydraulic damper for damping both the contraction and expansion of a vehicle ground supporting element such as, by way of example a wheel.

Generally the type of hydraulic damper utilized for this purpose is not sufficiently responsive to changes from compression damping as occurs during “jounce” and expansion damping as occurs during “rebound”. In addition because of the types of construction normally employed, insufficient damping from that desired must be accepted.

For example, a conventional prior art type damper is shown in FIGS. 1 and 2. For example, a hydraulic damper for the rear wheel of motorcycles is disclosed in Japanese Published Patent Document JP-A-Hei 6-127453.

FIG. 1 is a sectional view of a prior art hydraulic dampers indicated generally by the reference numeral 21 for the rear wheel of motorcycles. The damper 21 is comprised of an outer cylinder 22 in which a piston 23 is fitted to divide the interior of the outer cylinder 22 into a contraction side oil chamber C and an extension side oil chamber D. The piston 23 is fixed to a piston rod 24 that extends outwardly of the outer cylinder 22 for connection to a component of the vehicle suspension system, for example to body portion of the associated vehicle, which connection component is indicated by the reference numeral 25. In a similar manner, the outer cylinder is provided with a connection component 26 for connection to a component of the vehicle suspension system, for example to suspension arm for the wheel of the associated vehicle.

The contraction side oil chamber C receives compressive action in contraction or jounce stroke, while the extension side oil chamber D receives compressive action in extension or rebound stroke. First and second passages 27 and 28, respectively are formed in the piston for providing fluid communication between the contraction side oil chamber C and the extension side oil chamber D. At the extension chamber side opening 27a of the first passage 27 is provided a contraction time valve 29 capable of opening during contraction stroke of the piston rod 24. In a similar manner, at the contraction chamber side opening 28a of the second passage 28 is provided an extension time valve 31 capable of opening during extension stroke.

An in-shaft passage 24a is axially formed in the piston rod 24, to provide fluid communication with the contraction side oil chamber C. In addition a communication passage 24b is formed to provide fluid communication between the in-shaft passage 24a and the extension side oil chamber D. Thus, the contraction side oil chamber C and the extension side oil chamber D are interconnected with each other via the in-shaft passage 24a and the communication passage 24b.

A damping force regulating valve 24c is inserted, to be axially movable, into the piston rod 24. At the tip of the damping force regulating valve 24c, a conical needle 24d is formed to be located within the in-shaft passage 24a. By moving the position of the needle 24d back and forth, the amount of oil flowing from the needle 24d to the communication hole 24d is regulated, so as to adjust damping force in particular in low speed range during both the contraction stroke and the extension stroke.

A passage 22a positioned below the lowermost position of the piston 23 communicates with an inlet of a base valve 32. The base valve 32 is, in turn, in fluid communication with a sub tank 33.

With such a prior art type of hydraulic damper 21, damping force is produced when the piston 23 relatively moves in the axial direction within the cylinder 22 in response to the irregularities on the road surface. Damping force characteristics are set to realize maneuverability and ride comfort the user desires and to obtain damping force matching the road surface conditions. These conditions are illustrated in FIGS. 2A and 2B which are enlarged views of the area encompassed by the circle 2 in FIG. 1 and the flow directions are indicated by the arrows.

FIG. 10(A) shows the contraction or jounce stroke. As the piston 23 is pushed down, the pressure in the contraction side oil chamber C rises, while pressure in the extension side oil chamber D decreases. As a result, oil in the pressure in the contraction side oil chamber C pushes the contraction time valve 28 open the flow passes through the first passage 27 into the extension side oil chamber D. The flow passes through the in-shaft passage 24a and the communication hole 24b of the piston rod 24 into the extension side oil chamber D.

FIG. 10(B) shows the extension or rebound stroke. As the piston 23 is pulled up in this figure, pressure in the extension side oil chamber D rises and the pressure in the contraction side oil chamber C lowers. As a result, oil in the extension side oil chamber D pushes open the extension time valve 31 and moves through the second passage 28 into the contraction side oil chamber C, and also moves from the communication hole 24b of the piston rod 24 through the in-shaft passage 24a into the contraction side oil chamber C.

The flow through the base valve 32 during these respective conditions is shown respectively in FIGS. 3A and 3B, again by the directional arrows. Referring first to FIG. 3A this again shows the contraction or jounce stroke. As the piston rod 24 is inserted into the cylinder 22, an amount of oil corresponding to the volume of the piston rod 24 flows from the cylinder 22 to the base valve 32 and is sent to the sub tank 33. At this time, contraction side damping force is controlled by the base valve 32.

The total flows during the compression and expansion (jounce and rebound) are shown in FIGS. 4A and 4B, respectively. Referring first to the compression stroke (FIG. 4A), as the piston rod 24 is pushed into the cylinder 22, an amount of oil corresponding to the volume of the piston rod 24 flows to the base valve 32, so that damping force on the contraction side is obtained by the control of the base valve 32. However, since the oil acting to produce contraction side damping force is used only in the amount corresponding to the cross-sectional area of the piston rod 24, the flow rate is small and the damping force on the contraction side cannot be obtained efficiently relative to the total cross-sectional area of the cylinder 22.

If, with the intention of increasing the damping force, the oil flow to the extension side oil chamber D is restricted by additionally throttling the contraction time valve 29 of the piston 23, the pressure in the extension side oil chamber D tends to be negative and if so cavitation occurs. Accordingly, the damping force on the contraction operation is reduced.

Now referring to FIG. 4B and the rebound or expansion stroke, pressure in the contraction side oil chamber C lowers, and an amount of oil corresponding to the amount of displacement of the piston rod 24 is supplied, through the base valve 32, into the cylinder 22. In the area of the piston 23 portion, as the piston rod 24 is drawn out, an amount of oil corresponding to the cross-sectional area of the cylinder 22 minus the cross-sectional area of the piston rod 24 flows. Thus again the amount of fluid flowing is reduced.

In addition, under reversing conditions oil flows in opposite directions, a delay may occur before damping force is produced when switching from one mode to the other. The total effect of these conditions is illustrated in FIG. 5 which is a graph showing conventional and current performance requirements of the hydraulic damper for the damping forces on extension and contraction sides plotted against the piston speed. The upper side of the vertical axis, where the damping force (N) is above 0, represents the extension side, while the lower side, the contraction side. The curves of broken lines show conventional performance while solid lines depict the desired requirements. In other words, conventionally, the contraction side damping force is less than desired, while the extension side damping force is greater than desired.

It has been recognized by the inventors hereof that vehicles of light weight and high output such as sports models, require high stability and maneuverability than that obtained by the prior art units. They have understood that these vehicles require increased contraction side damping force and improved responsiveness of the extension side damping force. In other words, it is required to increase the contraction side damping force in comparison with the past, while on the extension side, the same performance as the contraction side is required. It is further required to obtain damping forces in both contraction and extension strokes while quickly responding to switching from one stroke to the other.

It is a principal object of this invention to provide a vehicle suspension system that employs a greater volume of fluid for damping the jounce or compression forces than merely the effective area of piston rod displacement.

It is a further object of the invention to improve the response to changes between jounce and rebound operations.

It is a yet further object of the invention to provide a suspension system wherein the damping is more equal between jounce and rebound. Such requirements of the current time cannot be fully met by means of the conventional constitution in which the damping force in particular during the contraction stroke is controlled with only the limited amount of oil corresponding to the inserted volume of the piston rod.

### SUMMARY OF THE INVENTION

This invention is adapted to be embodied in a suspension system for a vehicle supporting element for movement in jounce (compression) and rebound (expansion) that provides a greater amount of fluid displacement and more equal damping while at the same time being quicker to respond to reversals in direction of movement.

### BRIEF DESCRIPTION OF THE DRAWINGS

FIG. 1 is a side elevational view, with parts broken away and shown in section of a prior art type of vehicle suspension damper.

FIG. 2A is an enlarged cross sectional view of the area encompassed by the circle 2 in FIG. 1 showing the fluid flow during jounce (compression).

FIG. 2B is a view in part similar to FIG. 2A, but showing the fluid flow during rebound (expansion).

FIG. 3A is an enlarged cross sectional view showing the flow through the prior art base valve during jounce (compression).

FIG. 3B is a view in part similar to FIG. 3A, but showing the fluid flow during rebound (expansion).

FIG. 4A is a view in part similar to FIG. 11 but shows the amount of fluid displacement during jounce (compression).

FIG. 4B is a view in part similar to FIG. 1, but shows the amount of fluid displacement during rebound (expansion).

FIG. 5 is a graphical view showing a comparison of the actual and desired damping characteristics between those desired and those obtained by the prior art.

FIG. 6 is a side elevational view, with parts broken away and shown in section, in part similar to FIG. 1 but showing a vehicle suspension damper embodying the invention.

FIG. 7A is an enlarged cross sectional view of the area encompassed by the circle 7 in FIG. 6 showing the fluid flow during jounce (compression).

FIG. 7B is a view in part similar to FIG. 7A, but showing the fluid flow during rebound (expansion).

FIG. 8A is an enlarged cross sectional view of the area encompassed by the circle 8 in FIG. 6 showing the fluid flow during jounce (compression).

FIG. 813 is a view in part similar to FIG. 5A, but showing the fluid flow during rebound (expansion).

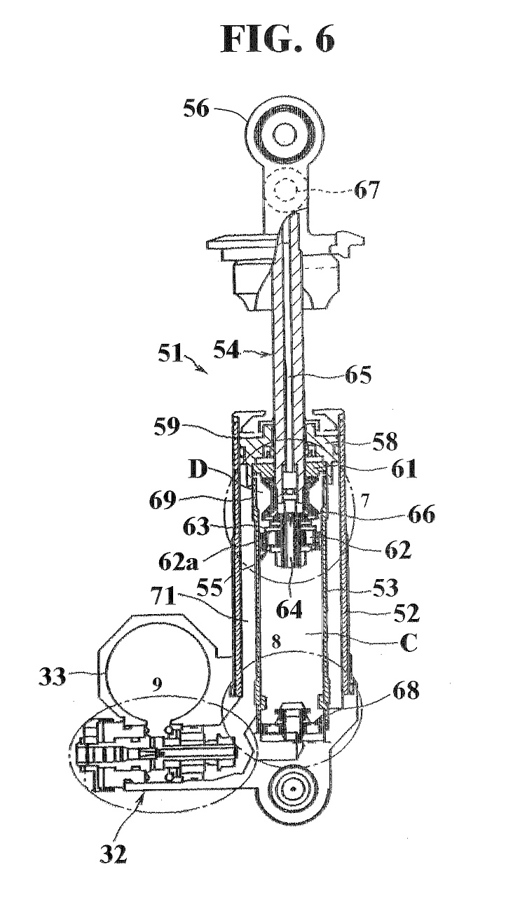

FIG. 9A is an enlarged cross sectional view of the area encompassed by the circle 9 in FIG. 6 showing the fluid flow during jounce (compression).

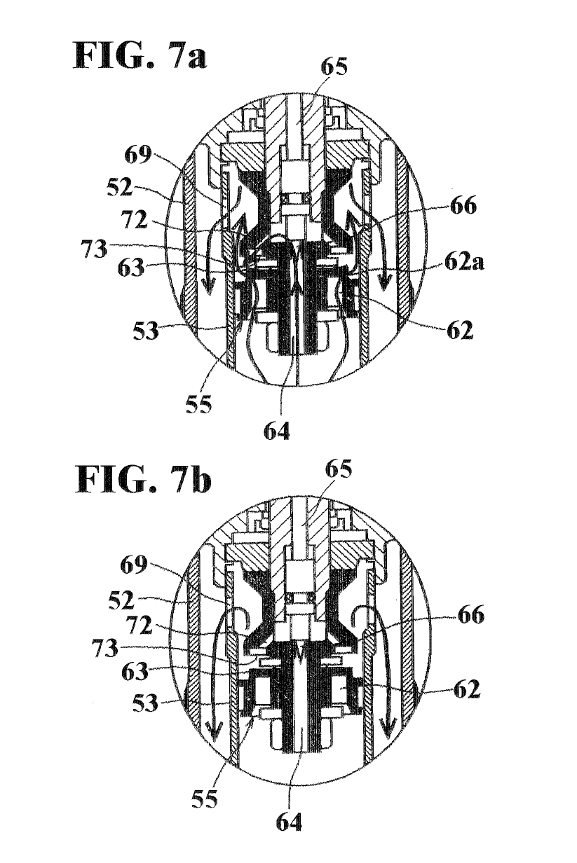

FIG. 9B is a view in part similar to FIG. 7A, but showing the fluid flow during rebound (expansion).

FIG. 10A is an enlarged cross sectional view, in part similar to FIG. 6, showing the fluid flow during jounce (compression).

FIG. 10B is an enlarged cross sectional view, in part similar to FIG. 6, showing the fluid flow during rebound (expansion).

FIG. 11 is a graph of damping forces when the piston of the hydraulic damper of the invention is displaced toward contraction and extension sides respectively in a sine wave motion.

FIG. 12 is a graph made by differentiating the displacement plotted as abscissa on the graph of FIG. 11, with the horizontal axis representing vibration speed of the piston; and the vertical axis, damping force.

FIG. 13 is a graphical view comparing the damping action of a conventional hydraulic damper and one embodying the invention.

### DETAILED DESCRIPTION

Referring now in detail to the drawings and initially to FIG. 6, a hydraulic damper embodying the invention is indicated generally by the reference numeral 51. The damper 51 includes an outer housing comprised of coaxially disposed inner and outer cylinders 52 and 53 of different diameters. A piston rod 54 is inserted to be axially movable in the inner cylinder 53.

A piston 55 is fixed to the lower end of the piston rod 54 to divide the interior of the inner cylinder 53 into a contraction side oil chamber C oil the lower end side of the piston 55 and an expansion side oil chamber D on the back side of the piston 55. The fore-end portion of the hydraulic damper 51 has a portion 56 configured for connection to a vehicle supporting component for example a wheel support member (not shown). The upper end portion 57 of the piston rod 54 is connected to a vehicle body (not shown).

A base member 58 is inserted in the base end side of the outer cylinder 52 and fixed in position by means of a retaining ring 59 or the like. The outer cylinder 52 and the inner cylinder 53 are fixed to each other for example through the base member 58. An elastic member 61 of rubber, coil spring, or the like that absorbs impact forces at the time of longest extension is attached to the base end side of the inner cylinder 53. On the axes of the base member 58 and the elastic member 61 are respectively formed shaft holes through which the piston rod 54 is inserted.

A passage 62 for providing fluid communication between the contraction side oil chamber C and the extension side oil chamber D is bored through the piston 55. A contraction time valve 63 for opening an extension side opening 62a of the passage 62 in contraction stroke is provided on the end face of the passage 62 facing the extension side oil chamber D. The contraction time valve 63 is comprised of either a single or plural reed valves made from for example, annular, thin plate springs, to be pushed open by the oil flow. An in-shaft passage 64 in fluid communication with the contraction side oil chamber C is formed coaxially with the piston 55.

An axially movable damping force regulating valve 65 is inserted in an opening coaxially with the piston rod 54. The fore-end of the damping force regulating valve 65 is formed with a conical needle 66. The needle 66 is placed to be movable axially back and forth between a position for fully closing the base end side opening of the in-shaft passage 64 and a position for fully opening it. Oil entering the in-shaft passage 64 in contraction stroke is controlled with the needle 66 and flows into the extension side oil chamber D. The damping force regulating valve 65 moves back and forth with an regulating member 67 to regulate damping force in contraction stroke particularly in the low speed range.

As with the prior art construction, on the fore-end side of the outer cylinder 52 are provided a base valve 32 and a reservoir tank 33 connected to the base valve 32. The base valve 32 for regulating damping force during extension. The entire fore-end portion of the outer cylinder 52 is made to be in fluid communication with the inlet of the base valve 32.

A one-way valve 68 is provided at the fore-end of the inner cylinder 53. The one-way valve 68 is opened up toward the inside of the inner cylinder 53 on an extension stroke or when the contraction side oil chamber C comes to a negative pressure.

A passage hole 69 leading to the outer cylinder 52 is formed in part of the inner cylinder 53 on the back side of the piston 55. When the piston rod 54 is inserted into the inner cylinder 53, an amount of oil corresponding to the inserted volume of the piston rod 54 flows through the passage hole 69 into the outer cylinder 52. The space defined between the outer cylinder 52 and the inner cylinder 53 serves as a passage 71 to the base valve 32, so that oil flows through the passage 71 and the base valve 32 into the reservoir tank 33.

While the cylinder of the illustrated embodiment of a double structure the communication with the base valve 32 may be provided by an external passage made of a tube or the like provided between the passage hole 69 and the inlet of the base valve 32.

Now the operation of the above hydraulic damper 51 will be described, first by reference to FIGS. 7A and 7B.

These figures show the state of the portion (7), around the piston 55, of the hydraulic damper 51 shown in FIG. 6. FIG. 7A shows contraction (jounce) stroke and with FIG. 7B shows the extension stroke. The arrows indicate the directions of oil flow.

When the wheel is pushed up by road surface irregularities and the hydraulic damper 51 comes to the compressed state, the cylinders 52 and 53 move toward the base end side, or upward in FIG. 7A. As a result, the piston 55 is relatively pushed down in as seen. At this time, as the pressure in the contraction side oil chamber C rises, oil flows up in the figure to open up the contraction time valve 63.

When the contraction time valve 63 opens as shown in FIG. 7A, oil flows through the passage 62 into the extension side oil chamber D, and damping force is produced. When the pressure in the contraction side oil chamber C rises, part of oil flows from the in-shaft passage 64 through the needle 66, and a second passage 72 bored in the piston 55 into the extension side oil chamber D. A valve 73 capable of opening in one direction toward the extension side oil chamber D is provided at the outlet of the second passage 62. As oil flows while pushing open the valve 73, pre-adjusted damping force is produced. At normal low speeds, oil flows through the in-shaft passage 64 into the extension side oil chamber D. Along with the increase in speed, oil pushes open the contraction time valve 63 to produce greater damping force.

As the piston rod 54 is inserted into the inner cylinder 53 during the contraction stroke (See FIGS. 6, 7a and 7b), the amount of oil corresponding to the inserted volume of the piston rod 54 becomes a surplus. This surplus oil flows, through the passage hole 69, into the outer cylinder 52. Thus, the pressure in the extension side oil chamber D is prevented from rising, and oil flow through the contraction time valve 63 becomes smooth to produce sufficient damping force during contraction.

During an extension (rebound) stroke in which the piston 55 moves in the opposite direction, the pressure in the extension side oil chamber D rises. During this time, as shown in FIG. 7(B), the contraction time valve 63 and the damping force regulating valve 65 are in closed state, and oil flows, through the passage hole 69, into the outer cylinder 52.

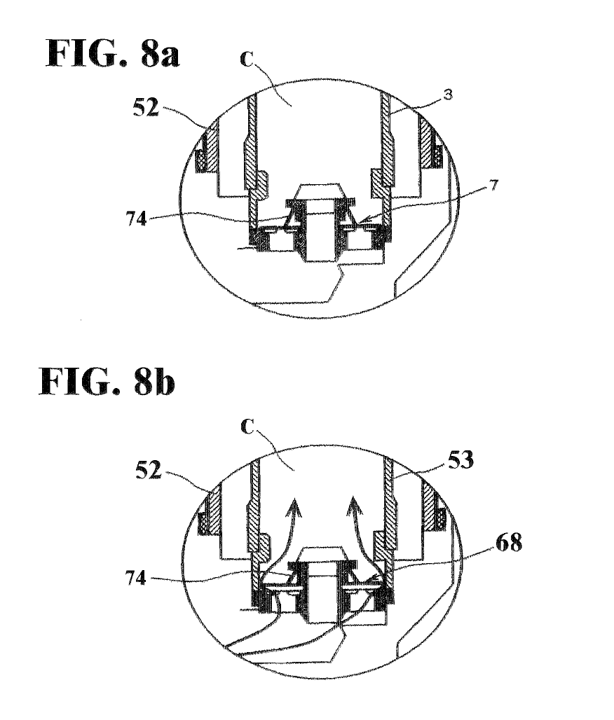

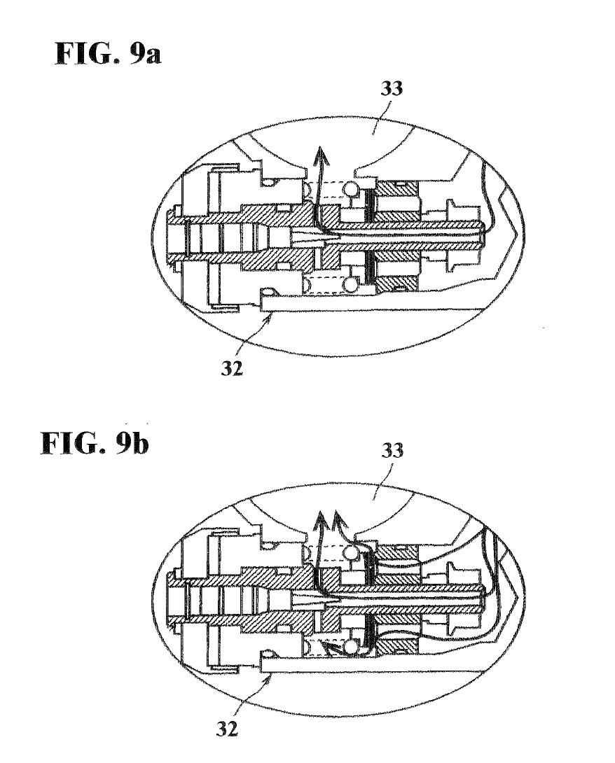

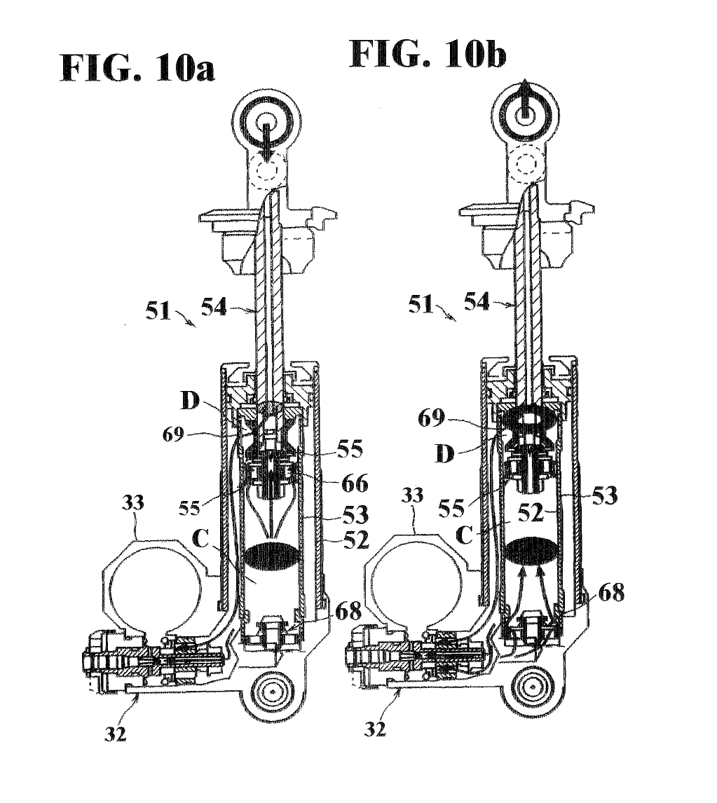

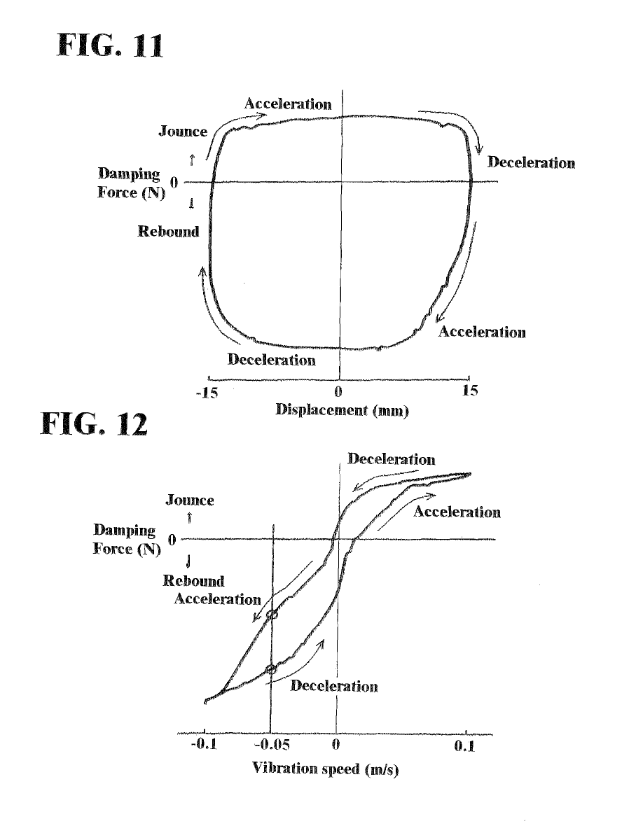

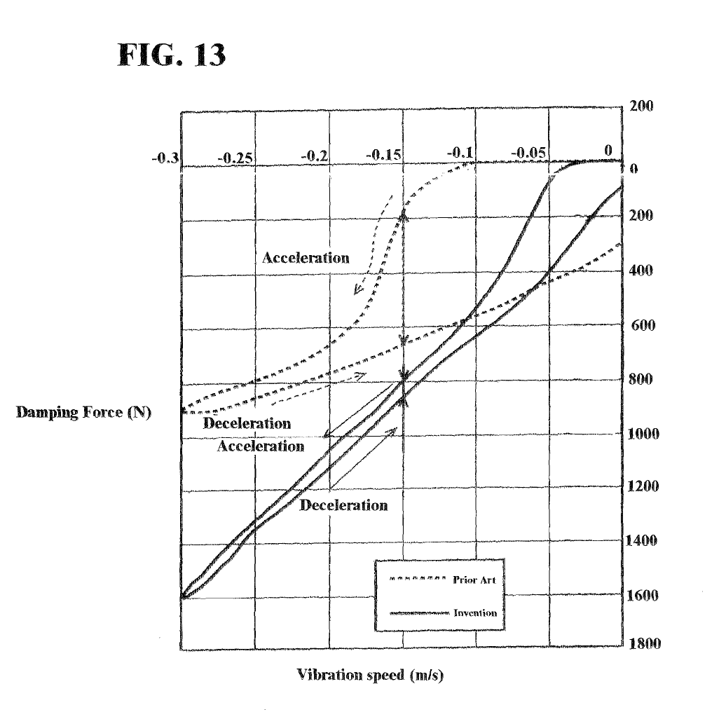

The operation of the one way valve 68 during the suspension travel will now be described by reference to FIGS. 8a and 8b. Again these two views show respectively the contraction (jounce) and expansion (rebound) operations with the fluid flow directions indicated by the arrows.

As the pressure in the contraction side oil chamber C rises during contraction stroke, as shown in FIG. 8a, the one-way valve 68 remains in closed state and no oil flow occurs through the one-way valve 68. However when the pressure in the contraction side oil chamber C lowers during extension stroke, a spring 74 deflects to open up the one-way valve 68 as shown in FIG. 8b. As a result, oil in the reservoir sub tank 33 flows, through the base valve 32 and the one-way valve 68, into the inner cylinder 53.

Referring now to FIGS. 9a and 9b, these show the flow conditions respectively through the base valve 32 during the contraction (jounce) and expansion (rebound) operations with the fluid flow directions again indicated by the arrows. During the contraction stroke as shown in FIG. 9a, the amount of oil corresponding to the inserted volume of the piston rod 54 flows through the passage hole 69 into the outer cylinder 52. This surplus amount of oil then flows through the base valve 32 and into the reservoir sub-tank 33. During the extension stroke, the oil flow as shown in FIG. 9b, reaches the base valve 32 to push up the valve in the base valve 32 and flows into the reservoir tank 33.

FIGS. 10a and 10b show the combined oil flow shown in FIGS. 7a and 7b, 8a and 8b and 9a and 9b in the contraction (jounce) and expansion (rebound) strokes, respectively. Again, arrows indicate the directions of oil flow.

During the contraction stroke, the amount of oil corresponding to the inserted volume of the piston rod 54 flows into the reservoir tank 33. The one-way valve 68 at the fore-end of the inner cylinder 53 remains closed by the internal pressure. Therefore, as shown in FIG. 59a, the amount of oil corresponding to the entire cross-sectional area of the inner cylinder 53 of the contraction side oil chamber C contributes to producing damping force during the contraction stroke. Therefore, sufficient damping force during contraction can be produced efficiently.

Furthermore, because the amount of oil corresponding to the inserted volume of the piston rod 54 flows into the reservoir tank 33 which controls damping force during extension stroke, it is possible to cause oil to flow instantaneously into the contraction side oil chamber C when the stroke switches from contraction to extension. Thus, responsiveness during stroke switching is improved.

During the extension stroke as shown in FIG. 10b, the amount of oil iii the extension side oil chamber D corresponding to the cross-sectional area of the inner cylinder 53 minus the cross-sectional area of the extended piston rod 54 flows through the passage hole 69 into the base valve 32 which serves as an extension damping force producing section. In addition, the amount of oil corresponding to the extended piston rod 54 is sent, as described above into the reservoir tank 33 during the contraction stroke. Therefore, when the one-way valve 68 of the inner cylinder 53 opens up, an amount of oil corresponding to the whole cross-sectional area of the inner cylinder 53 flows into the contraction side oil chamber C to contribute to producing extension damping force. Thus, sufficient extension damping force is produced efficiently.

Furthermore, with the simple constitution as described above, the directions of oil flow during both contraction and extension stroke become the same. Therefore, it is possible to produce damping force in opposite direction smoothly without delay when switching from one stroke to the other.

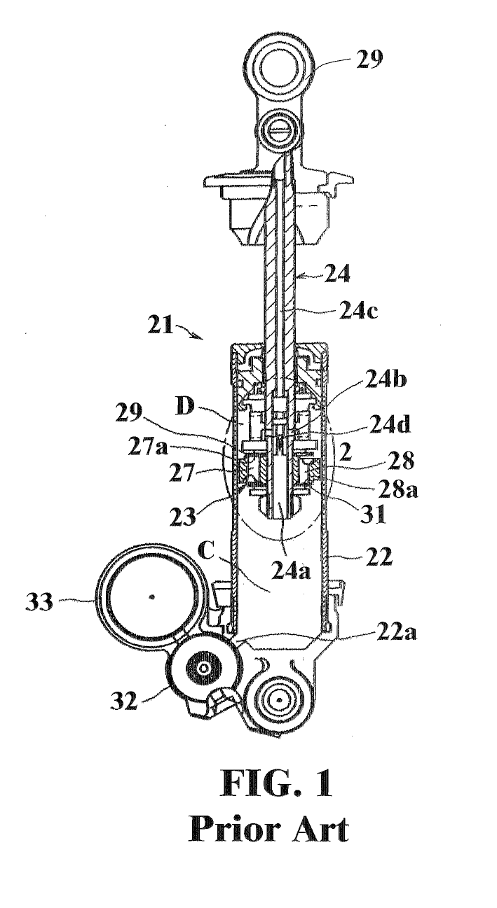

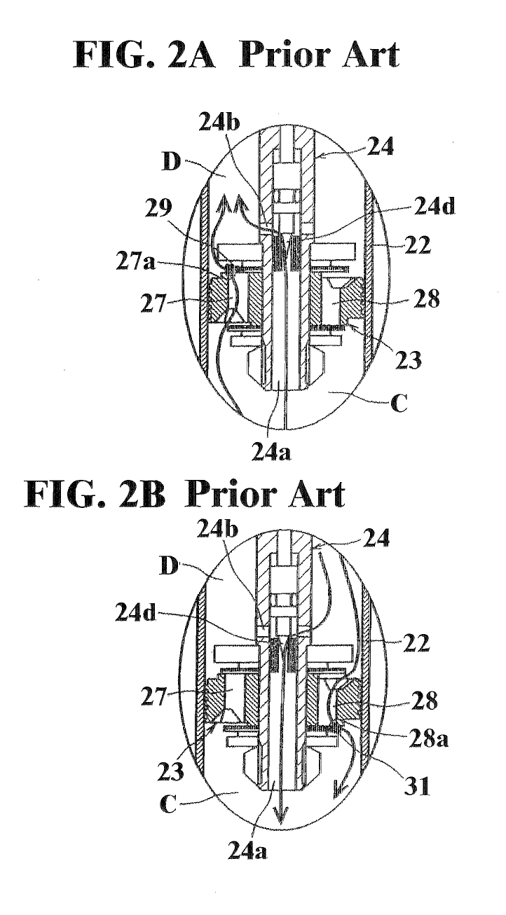

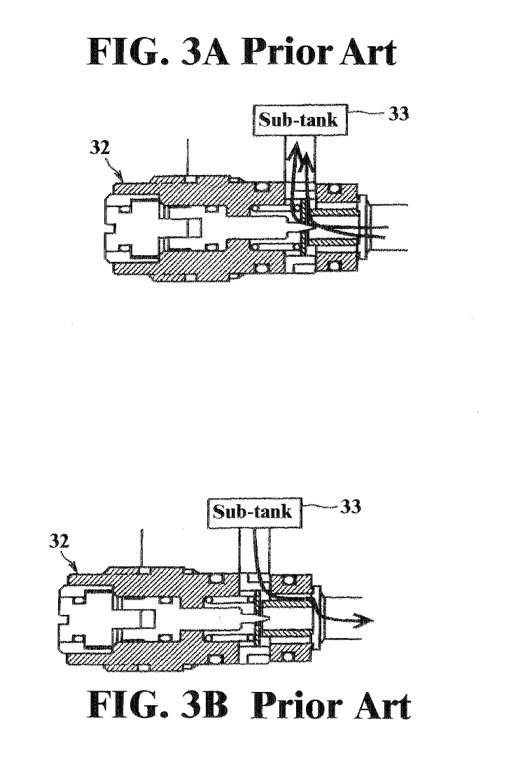

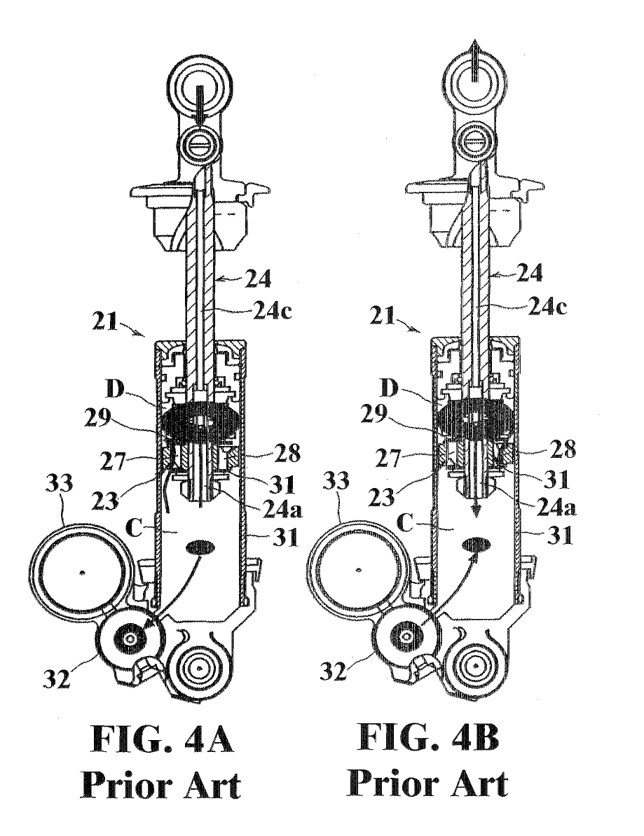

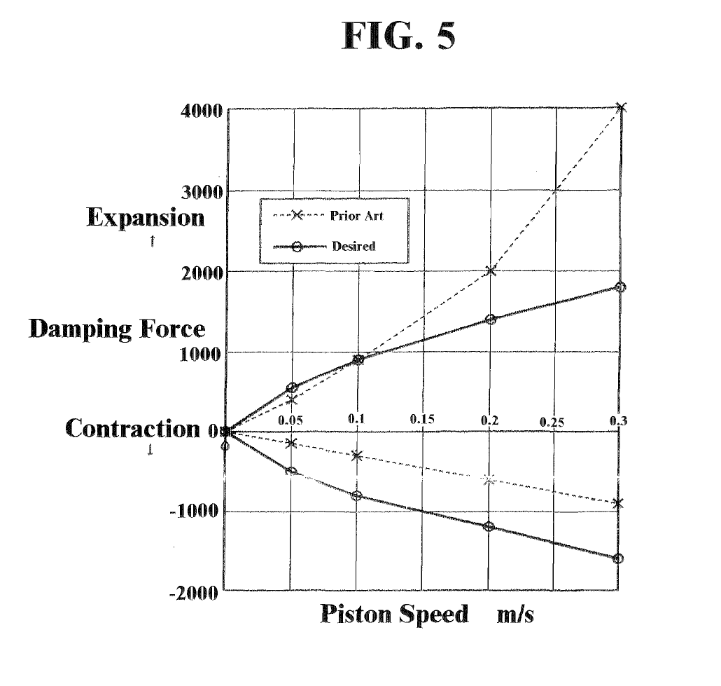

The performance of the hydraulic damper 51 embodying the invention in a dynamic condition may be understood by reference to FIG. 1 which is a graph of damping forces when the piston 55 of the hydraulic damper 51 of the invention is displaced toward contraction and extension sides respectively in sine wave motion. The horizontal axis represents displacement, and the vertical axis represents damping force. The portion above 0 (N) of the vertical axis represents extension (jounce) side load, and the side below it represents contraction (rebound) side load. As an example, tracing the curve from 0 (N) upward represents the state of acceleration on the extension side; from top domes toward 0(N), deceleration on the extension side. Tracing from 0(N) downward, represents acceleration on the contraction side; up toward 0(N), deceleration on the contraction side.

This graph visually shows the relationship between displacement and damping force, or change in damping force with respect to displacement, due to reciprocal motion of the piston 55. However, it is hard to determine from this graph if performance required of a hydraulic damper is met.

FIG. 12 is a graph made by differentiating the displacement plotted as abscissa on the graph of FIG. 11, with the horizontal axis representing vibration speed of the piston; and the vertical axis, damping force. Like FIG. 11, the side above 0 (N) on the vertical axis represents extension side load; the side below it, contraction side load. Tracing the curve from 0 (N) upward represents the state of acceleration on the extension side; from top down toward 0(N), deceleration on the extension side. Tracing from 0(N) downward, represents acceleration on the contraction side; up toward 0(N), deceleration on the contraction side.

This graph shows that the curves of acceleration and deceleration are closer to each other. Thus more similar damping forces to each other the obtained if the curves of acceleration and deceleration are superimposed That is substantially the same damping forces are obtained in both acceleration and deceleration. It is also easy to determine if damping force responds appropriately without delay to changes in vibration speed and to switching of oscillation between the contraction side and the extension side

From this graph, it is possible to determine the performance of the hydraulic damper of the invention by comparing damping force values on acceleration and deceleration at a vibration speed that is half the peak value of the vibration speed. For example, in case the performance on the contraction side of the example of FIG. 12 is determined, the difference between acceleration side and deceleration side at 0.05 m/s, half the vibration speed of 0.1 m/s, is indicated as a rate of decrease in damping force.

Referring now to FIG. 13, this is a graph of comparison by the method of FIG. 12 between the inventive hydraulic damper shown in FIG. 6 and the conventional hydraulic damper shown in FIG. 1 for the contraction side damping force.

As seen in this graph, a difference between damping forces on acceleration and deceleration sides is determined at a vibration speed of −0.15 m/s, half the peak value of −0.3 m/s. The conventional damper showed −162 N in acceleration and −668 N in deceleration, which means a rate of decrease of −76% on the acceleration side from the deceleration side. The hydraulic damper of the invention showed −800 N in acceleration and −860 N in deceleration, with a rate of decrease of −7%. Thus, the hydraulic damper of the invention showed great improvement in damping force response.

Of course those skilled in the art will recognize that the foregoing example is only one specific form the invention may take. Those skilled in the art will readily realize that various changes and modifications may be made without departing from the spirit and scope of the invention, as defined by the appended claims.

1. A suspension system for a vehicle supporting element for movement in jounce and rebound comprised of a hydraulic damper disposed between the vehicle and the vehicle supporting element that provides a greater amount of fluid displacement and more equal damping while at the same time being quicker to respond to reversals in direction of movement.

2. A hydraulic damper as set forth in claim 1 comprised of cylinder adapted to be affixed to one of the vehicle and the vehicle supporting element, a piston adapted to be affixed to the other of the vehicle and the vehicle supporting element and dividing said cylinder into a contraction side oil chamber and an extension side oil chamber, and configured such that substantially equal fluid displacement from said cylinder during extension and contraction of the piston rod in substantially equal relative movement in both directions.

3. A hydraulic damper as set forth in claim 2 wherein the fluid displaced during the relative movement is transferred between the cylinder and a fluid reservoir.

4. A hydraulic damper as set forth in claim 3 wherein at least a part of the fluid displaced from the side of the piston opposite to the side from which the piston rod extends during a compression stroke is transferred to a fluid reservoir external to and surrounding the cylinder.

5. A hydraulic damper as set forth in claim 4 wherein a portion of the fluid displaced from the side of the piston through which the piston rod extends is transferred to a fluid reservoir external to the cylinder through a base valve at the base of the cylinder during an expansion stroke.

6. A hydraulic damper as set forth in claim 3 wherein the fluid displaced from the side of the piston opposite to the side from which the piston rod extends is transferred to a fluid reservoir external to the cylinder through a base valve at the base of the cylinder during a compression stroke.

7. A hydraulic damper as set forth in claim 3 wherein at least a part of the fluid displaced from the side of the piston opposite to the side from which the piston rod extends during a compression stroke is transferred to the side of the piston on the side where the piston rod extends through a damping valve.

8. A hydraulic damper as set forth in claim 7 wherein a portion of the fluid displaced from the side of the piston through which the piston rod extends is transferred to a fluid reservoir external to the cylinder through a base valve at the base of the cylinder during an expansion stroke.

9. A hydraulic damper as set forth in claim 8 wherein the fluid displaced from the side of the piston opposite to the side from which the piston rod extends is transferred to a fluid reservoir external to the cylinder through a base valve at the base of the cylinder during a compression stroke.
